(19) United States
(12) Patent Application Publication
(10) Pub. No.: US 2008/0172154 A1
(43) Pub. Date: Jul. 17, 2008

(54) OPERATION GUIDING DEVICE FOR ON-VEHICLE ACCESSORY

(75) Inventors: Yasuhiro TANAKA, Kariya-city (JP); Nobutomo TAKAGI, Okazaki-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/964,269

(22) Filed: Dec. 26, 2007

(30) Foreign Application Priority Data
Jan. 11, 2007 (JP) 2007-3923

(51) Int. Cl. G06F 17/00

(52) U.S. Cl. 701/36

(57) ABSTRACT

An operation guiding device for a vehicle equipped with a plurality of accessories and operation members for operating the accessories is configured by a control unit that carries out detecting a vehicle condition, determining at least one of the operation members to operate an appropriate one of the accessories based on the vehicle condition and illuminating the at least one of the operation members to guide a user to operate the appropriate accessory.

### CROSS REFERENCE TO RELATED APPLICATION

The present application is based on and claims priority from Japanese Patent Application 2007-3923, filed Jan. 11, 2007, the contents of which are incorporated herein by reference.

### BACKGROUND OF THE INVENTION

1. Field of the Invention

The present invention relates to an operation guiding device that guides a user to appropriately operate an accessory or a system mounted in a vehicle according to a vehicle condition.

2. Description of the Related Art

JP-2005-335555-A discloses an on-vehicle information presenting device that presents to a user one or some of operation members that is or are required to operate an accessory or system of a vehicle when the user gets in or gets off the vehicle, thereby preventing the user from neglecting necessary operation of the accessory or the system. In this information presenting device, an operation that is required when the user gets in or gets off the vehicle, such as closing windows or turning off head lamps, are memorized together with an operation pattern. The information presenting device presents to the user the required operation when the user takes some action that indicates the user's getting off the vehicle, such as pulling up a parking brake lever.

If, however, the user is not accustomed to operation of the accessory of the vehicle, the user may not find out an operation member, such as a switch, to operate the accessory or system even if the user recognizes the required operation.

### SUMMARY OF THE INVENTION

Therefore, an object of the invention is to provide an operation guiding device that guides the user to operate on-vehicle accessory or system as required or recommended in a certain condition of a vehicle.

According to a feature of the invention, an operation guiding device is used for a vehicle equipped with a plurality of accessories or systems and operation members for operating the accessories or systems. The operation guiding device includes first means for detecting a vehicle condition, second means for determining at least one of the operation members to operate an appropriate one of the accessories or systems based on the vehicle condition and third means for illuminating the at least one of the operation members to guide a user to operate the appropriate accessory or systems.

In the above operation guiding device, the first means also detects a user's operation of at least one of the operation members; the second means examines whether the user's operation is appropriate or not based on the operation of at least one of the operation members carried out by the user to determine at least appropriate one of the operation members if the user's operation is judged as being not appropriate; and third means illuminates the at least appropriate one of the operation members.

The above operation guiding device further includes identifying means for providing identification data that identify a plurality of users of a vehicle, memorizing means for memorizing the users by operation patterns of operating a plurality of the operating members along with the identification data, wherein the second means determines at least one of the operation members for one of the users aboard the vehicle based on one of the memorized operation patterns that corresponds to a portion of the identification data identifying the one of the users aboard the vehicle.

This operation guiding device further includes pattern examining means for examining whether an operation pattern of the operation members by the one of the users aboard the vehicle corresponds to one of the operation patterns memorized by the memorizing means, and updating means for updating the operation patterns if the operation pattern of the operation members by the one of the users aboard the vehicle does not correspond to any one of the operation patterns memorized by the memorizing means.

The above operation guiding device as in claim 4, further comprising means for examining whether operation of an operation member by a user is inappropriate or not, and means for alarming if the operation of the operation member by the user is inappropriate. In this operation guiding device, the updating means does not update if the examining means for examining judges that the operation of the operation member by the user is inappropriate.

### BRIEF DESCRIPTION OF THE DRAWINGS

Other objects, features and characteristics of the present invention as well as the functions of related parts of the present invention will become clear from a study of the following detailed description, the appended claims and the drawings. In the drawings:

FIG. 1 is a block diagram of a operation guiding device according to the first embodiment of the invention;

FIG. 2 is a flow diagram of a control process of the operation guiding device according to the first embodiment;

FIG. 3 is a flow diagram of a control process of the operation guiding device according to the second embodiment of the invention;

FIG. 4 is a flow diagram of a control process of the operation guiding device according to the third embodiment of the invention; and

FIG. 5 is a flow diagram of a control process of the operation guiding device according to the fourth embodiment of the invention.

### DETAILED DESCRIPTION OF THE PREFERRED EMBODIMENTS

Some preferred embodiments according to the present invention will be described with reference to the appended drawings.

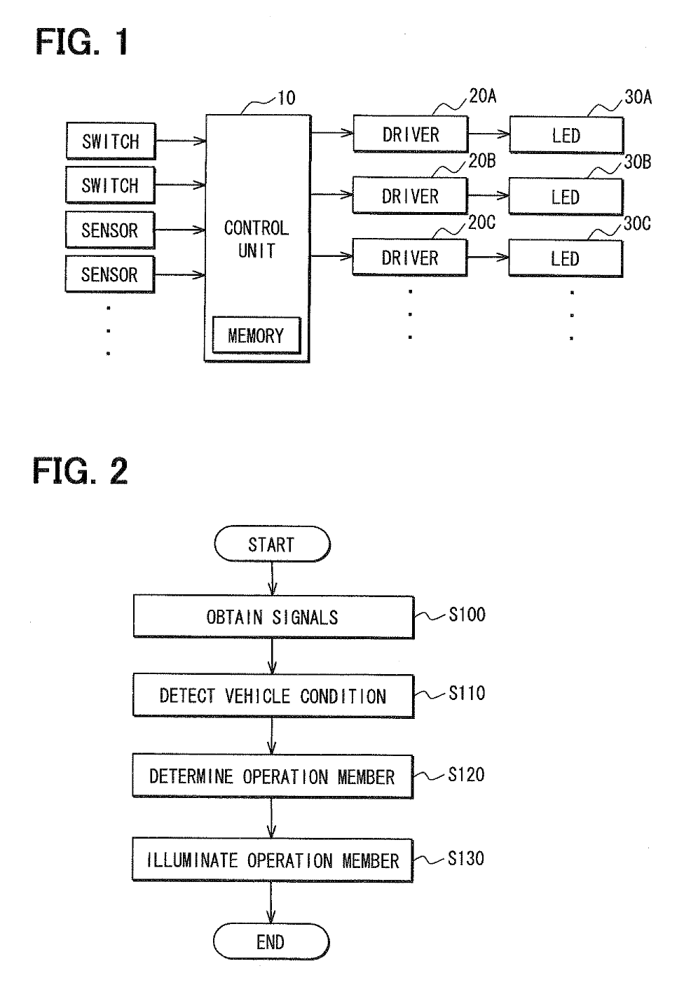

An operation guiding device according to the first embodiment of the invention will be described with reference to FIGS. 1 and 2.

As shown in FIG. 1, the operation guiding device is configured by a control unit 10. The control unit 10 directly or indirectly obtains signals from various switches and/or sensors via communication lines to detect a vehicle condition. The various sensors and/or switches may include an ignition key switch, a seat belt sensor, a side brake sensing switch, a gear position sensor of a transmission system, a door sensor, a door lock sensor, a head lamp sensor, a power switch of a cruise control system, an engine rotation sensor, a vehicle speed sensor, a power switch of a navigation system, a vehicle position sensor of a navigation system, road information data, etc.

The control unit 10 obtains one or more signals from one or some of the above-stated sensors and/or switches to detect a vehicle condition. For example: if a signal indicating that a door of a vehicle is unlocked is sent from the door lock sensor when the engine thereof stops, it is presumed that a user gets in the vehicle; if it is detected by the vehicle position sensor of a navigation system that the position of the vehicle is on a speed way, it is presumed that the vehicle runs at a high speed; and if a signal of the side brake sensor indicates that the side brake is pulled up, the door sensor indicates that a door is opened, and the ignition key switch indicates that the engine stops, it is presumed that the user gets off the vehicle.

The control unit 10 is connected with driver circuits 20A-20C that respectively drive light emitting elements 30A-30C. The control unit 10 sends drive signals to the driver circuits 20A-20C to selectively turn on one or more of light emitting elements 30A-30C. Incidentally, the control unit 10 may make another control unit turn on desired light emitting elements via a communication line.

Each of the light emitting elements 30A-30B is constructed of a blue or red light emitting diode (LED) that illuminates an operation member such as a switch or a brake pedal. If the operation member is disposed at an instrument panel, the LED is disposed at the back of the operation member to illuminate it as a backlight. If the LED can not be fixed at the back of the operation member such as the brake pedal, the LED is disposed at a position where the LED can illuminate the operation member as a spot light.

Operation of the control unit 10 will be described with reference to a flow diagram shown in FIG. 2.

At first, one or more signals are obtained from the above-stated switches or sensors at step S100. Then, a vehicle condition is detected based on the obtained signals at S110. Thereafter, an operation member of an accessory or a system that is required for the user to operate in a specific vehicle condition is determined according to, or selected from, data stored in a memory of the control unit 10 at S120 Incidentally, the operation members required to be operated in various vehicle conditions are designated beforehand and stored in the memory. Then, one or more drive signals are sent to the driver circuits 20A-20C to drive one or some of the light emitting elements 30A-30C to illuminate the selected one or some of the operation members at S130.

For example: when a user gets in a vehicle equipped with a pushbutton type engine starting system, a pushbutton switch and a brake pedal are illuminated so as to guide the user to push a pushbutton switch while depressing a brake pedal; when the vehicle runs at a higher speed than a preset speed on a speedway, a switch of a cruise control system is illuminated to recommend the user to operate the cruise control system; and if the user forgets to turn off headlamps when getting off the vehicle, the headlamp switch is illuminated with a buzzer sound. Thus, even if the user is not accustomed to operation of the vehicle, the user can easily recognize an operation member that is required or recommended to operate.

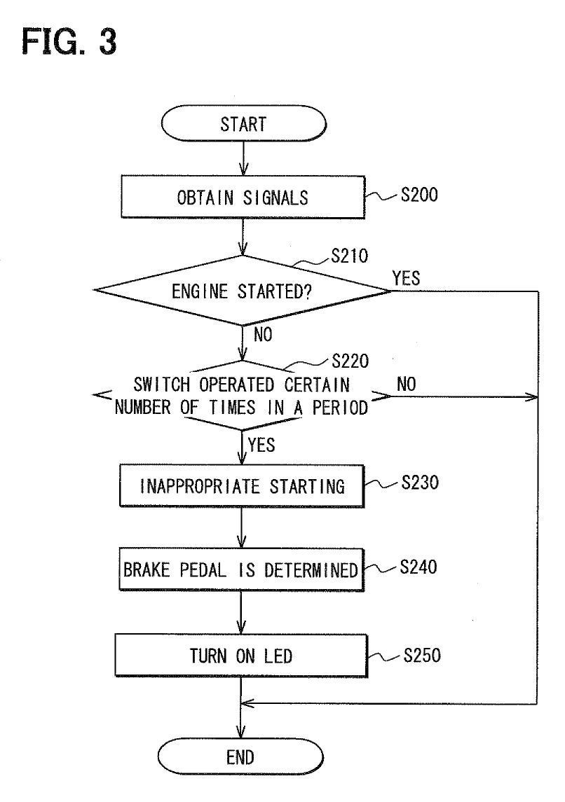

An operation guiding device according to the second embodiment of the invention will be described with reference to FIG. 3. Since the construction of this operation guiding device is the same as that of the first embodiment, only the operation thereof, in particular the operation of the operation guiding device of a pushbutton type engine starting system, will be described.

At step S200, signals from various sensors and or switches are obtained. Then, whether an engine has started or not is examined at S210. If it is found that the engine has not started, step S220 follows, where whether an engine starting pushbutton switch is operated a certain number of times in a predetermined short time period or not is examined. If the result of the examination is YES, it is determined that the user does not appropriately operate the engine starting system at S230, because it is not usual to operate the engine switch many times in a short time period.

At S240, it is determined to illuminate the brake pedal in order to guide the user to appropriately start the engine, At S250, a light emitting element for illuminating the brake pedal is turned on. Thus, the user is guided to depress the brake pedal to start the engine. It may be also effective to illuminate the pushbutton switch at S250 by another light emitting element.

An operation guiding device according to the third embodiment of the invention will be described next. The construction of this operation guiding device is almost the same as that of the first embodiment except that this operation guiding device is equipped with a user identifying unit.

The user identifying unit includes a camera disposed in the passenger compartment of the vehicle to discriminate the user from others by the features of the user's countenance. The user identifying unit may discriminate the user by the fingerprint, glottis, venous configuration, vehicle seat position, and/or ID code of a key switch (of a smart entry system) of the user. In this operation guiding device, the operation members and operation order that correspond to an individual operation pattern are memorized as data along with the user identification and a vehicle condition when the user operates the accessory.

For example, it has been observed that one of the users takes an action of starting an engine after fastening a seat belt, while another takes the action of the starting the engine before fastening the seat belt.

When the user gets in the car in the same vehicle condition, this guiding device guides the user to operate the operation member and operation order according to the memorized data. Accordingly, even if there are plural users of a vehicle, operation guidance of various accessories that is appropriate or favorable for each user can be provided.

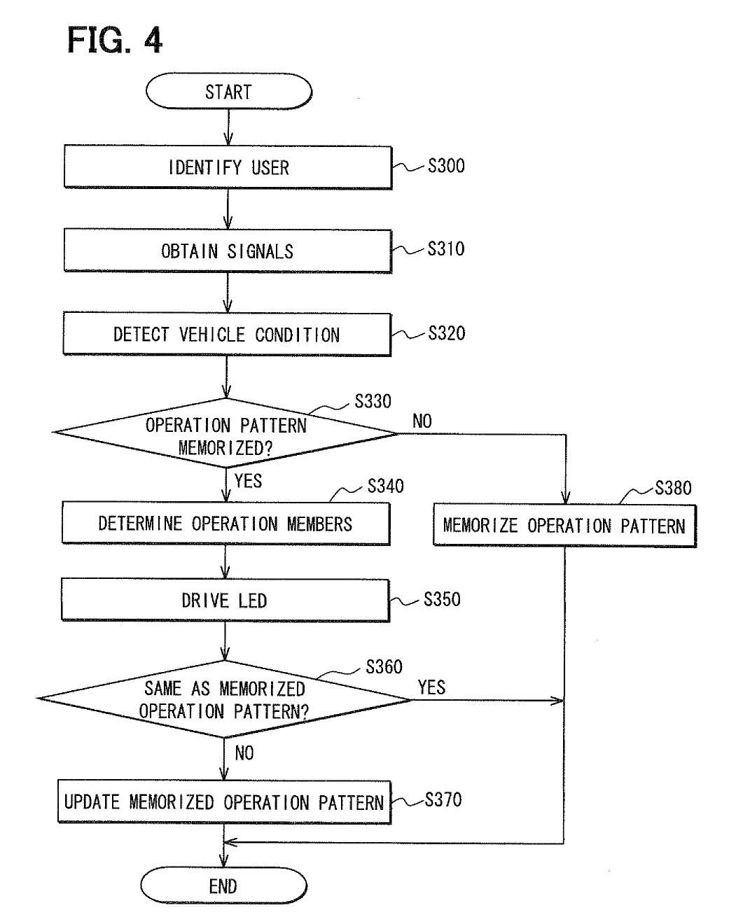

As shown in FIG. 4, the identification of the user is carried out by identifying unit at S300. Then, signals from various switches and/or sensors are obtained at S310, and the vehicle condition is detected at S320.

At S330, whether an operation pattern related to an identified user and a detected vehicle condition is memorized or not is examined. If it is judged that the operation pattern is not memorized, the step goes to S380, where the operation pattern, on which the user has subsequently operated the operation members in an individual operation order, is newly memorized along with the vehicle condition. If, on the other hand, it is judged that the operation pattern is memorized at S330, the step goes to S340, where the requested or recommended operation members to be illuminated in the memorized order by corresponding one or ones of the light emitting elements 30A-30C at the next step S350 are determined according to the memorized operation pattern. At S360, whether the operation of the operation members by one of the users corresponds to one of the memorized operation patterns or not is examined. If the examination result is NO, the step goes to S370, where the memorized operation patterns are updated. Therefore, the one of the users can be guided appropriately next time. Incidentally, it is possible to stop guidance if the examination result at S360 is NO, It is also possible to register or change the operation pattern by the user.

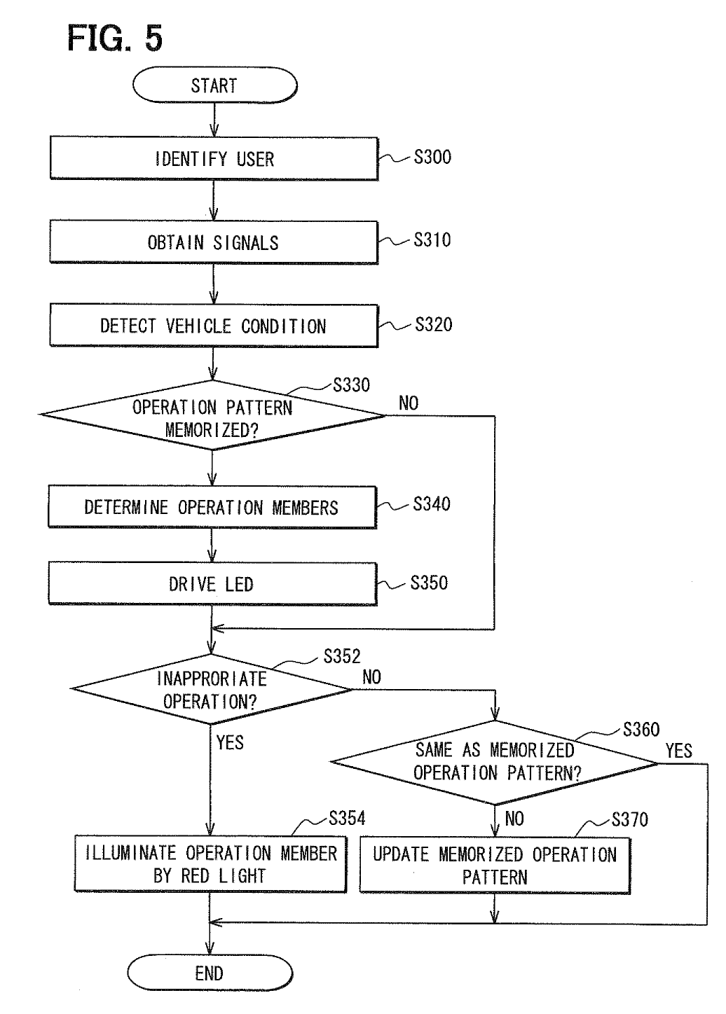

An operation guiding device according to the fourth embodiment of the invention will be described next with reference to FIG. 5. The construction of this operation guiding device is almost the same as that of the third embodiment except the light emitting elements.

Normally, the operation guidance is carried out by illuminating operation members that are required to operate with blue light emitted by one or some of the light emitting elements 30A-30C. On the other hand, the operation guidance for alarming undesired operation of the operation member is carried out by red blinking light emitted by one or some of the light emitting elements 30A-30C. The above operations are controlled by the control unit 10.

Some examples of the undesired operation are as follows: the ignition key is turned off while the vehicle is running or when the gear position is located at a position other than parking; the seat belt is unfastened while the vehicle is running; the accelerator pedal is depressed when the parking brake lever is pulled up; the navigation system is operated while the vehicle is running; and the door is unlocked while the vehicle is running.

The control process of the operation guiding device according to the fourth embodiment is almost the same as that of the operation guiding device according to the third embodiment except that steps S352 and S354 are added to warn a user of an inappropriate operation of operation members. As shown in FIG. 5, if an operation pattern is memorized through the steps S300-S350, the guidance is carried out according to the operation pattern. Then, whether operation of an operation member by a user is inappropriate or not is examined at S352. If it is judged that the operation is inappropriate (YES), the operation member that has been operated by the user is illuminated by blinking red light at S354. If, on the other hand, it is judged that the operation is appropriate, the steps S360 and S370 follow. At S360, whether the operation pattern of the operation members by one of the users corresponds to one of the memorized operation patterns or not is examined. If the examination result is NO, the step goes to S370, where the memorized operation patterns are updated.

Thus, the updating operation at S370 is carried out only when it is judged that the operation is appropriate (i.e. NO) at S352. Therefore, an operation pattern formed by inappropriate operation can be prevented from being memorized.

In the foregoing description of the present invention, the invention has been disclosed with reference to specific embodiments thereof. It will, however, be evident that various modifications and changes may be made to the specific embodiments of the present invention without departing from the scope of the invention as set forth in the appended claims. Accordingly, the description of the present invention is to be regarded in an illustrative, rather than a restrictive, sense,

What is claimed is:

1. An operation guiding device for a vehicle equipped with a plurality of accessories and operation members for operating the accessories, the operation guiding device comprising:
means for detecting a vehicle condition;
means for determining at least one of the operation members to operate an appropriate one of the accessories based on the vehicle condition; and
means for illuminating the at least one of the operation members to guide a user to operate the appropriate accessory.

2. An operation guiding device as in claim 1, wherein:
the means for detecting a vehicle condition detects a user's operation of at least one of the operation members;
the means for determining at least one of the operation members examines whether the user's operation is appropriate or not based on the operation of at least one of the operation members carried out by the user, determines at least appropriate one of the operation members if the user's operation is judged as being not appropriate; and
the means for illuminating illuminates the at least appropriate one of the operation members.

3. An operation guiding device as in claim 1, further comprising means for providing identification data that identify a plurality of users of a vehicle;
means for memorizing the users by operation patterns of operating a plurality of the operating members along with the identification data, wherein the means for determining at least one of the operation members determines at least one of the operation members for one of the users aboard the vehicle based on one of the memorized operation patterns that corresponds to a portion of the identification data identifying the one of the users aboard the vehicle.

4. An operation guiding device as in claim 3, further comprising means for examining whether an operation pattern of the operation members by the one of the users aboard the vehicle corresponds to one of the operation patterns memorized by the means for memorizing; and
means for updating the operation patterns if the operation pattern of the operation members by the one of the users aboard the vehicle does not correspond to any one of the operation patterns memorized by the means for memorizing.

5. An operation guiding device as in claim 3, wherein the operation patterns can be manually registered.

6. An operation guiding device as in claim 4, further comprising means for examining whether operation of an operation member by a user is inappropriate or not; and
means for alarming if the operation of the operation member by the user is inappropriate.

7. An operation guiding device as in claim 6, wherein the means for updating memorized operation patterns does not update if the means for examining judges that the operation of the operation member by the user is inappropriate.
